(19) United States
(12) Patent Application Publication
(10) Pub. No.: US 2020/0380544 A1
(43) Pub. Date: Dec. 3, 2020

(54) FARMING SUPPORT SYSTEM

(71) Applicant: TOYOTA JIDOSHA KABUSHIKI KAISHA, Toyota-shi (JP)

(72) Inventor: Kenji KITA, Nisshin-shi (JP)

(21) Appl. No.: 16/877,645

(22) Filed: May 19, 2020

(30) Foreign Application Priority Data
Jun. 3, 2019 (JP) 2019-103915

(51) Int. Cl. G06Q 30/02; G06Q 10/08; G06Q 50/02

(52) U.S. Cl. CPC G06Q 30/0206; G06Q 50/02; G06Q 10/08345

(57) ABSTRACT

Provided is a farming support system capable of precisely calculating the cost of a crop to be planted for sales. A farming support system includes: a storage unit to store a unit cost for each of a plurality of types of crops per unit planting area, the unit cost being calculated from a total cost including: a preparation cost required for a preparation operation; a farm-work cost required for farm work; and a shipping cost required for shipping operation; a condition setting unit configured to set a crop to be planted and a planting area for the crop; a unit-cost selection unit configured to select a unit cost corresponding to the crop to be planted from unit costs of the plurality of crops stored in the storage unit; and a cost calculation unit configured to calculate a cost of the crop to be planted based on the set planting area and the selected unit cost.

### CROSS REFERENCE TO RELATED APPLICATIONS

The present application claims priority from Japanese patent application JP 2019-103915 filed on Jun. 3, 2019, the content of which is hereby incorporated by reference into this application.

### BACKGROUND

### Technical Field

The present disclosure relates to a farming support system to conduct farm work in accordance with farming information.

### Background Art

For conventional farming management, the manager of farming produces and sells a plurality of items and varieties of crops in combination (i.e., a plurality of crops). To this end, the manager has to understand the cost of each of the crops that are planted and cultivated in their managed farm field. It is therefore important for the manager to understand the personnel cost required for each of the crops in the farm field. From this viewpoint, JP 2015-191477 A, for example, proposes an agricultural support system configured to calculate the personnel cost of farmers based on the information on the work hours input to mobile terminals that the farmers have.

### SUMMARY

The procedure to sell the crops as commodities includes a preparation operation before planting the crops in the farm field, and a shipping operation of shipping the harvested crops. The expense required for the working hours of these operations greatly affects the cost of the crops. Especially in the case of cultivating a plurality of types of crops, these operations may overlap among the crops. This causes a difficulty to correctly calculate the cost of the crops. As a result, it is difficult for the manager to correctly understand the input cost required to sell the crops to be planted from now.

In view of the above, the present disclosure provides a farming support system capable of correctly calculating the cost of a crop to be planted for sales.

In view of the above, a farming support system according to the present disclosure includes: a storage unit configured to store a unit cost for each of a plurality of types of crops per unit planting area, the unit cost being calculated from a total cost including: a preparation cost required for a preparation operation before planting of the crop; a farm-work cost required for farm work of the crop after the preparation operation, the farm work including planting through harvesting of the crop; and a shipping cost required for shipping operation to ship the harvested crop; a condition setting unit configured to set a crop to be planted and a planting area for the crop; a unit-cost selection unit configured to select a unit cost corresponding to the crop to be planted from unit costs of the plurality of crops stored in the storage unit; and a cost calculation unit configured to calculate a cost of the crop to be planted based on the set planting area and the selected unit cost.

The storage unit of the present disclosure stores a unit cost of a crop per unit planting area for each of a plurality of types of crops. The unit cost of a crop is calculated based on the total cost including not only the farm-work cost required for the farm work from planting of the crop at the farm field to harvesting the crop but also the preparation cost before the farm work and the shipping cost after the farm work. The unit cost of each crop stored in the storage unit therefore is calculated while considering the cost more precisely.

To calculate the unit cost of a crop to be planted, the condition setting unit of the farming support system firstly sets a crop to be planted and a planting area of the crop to be planted. Next the unit-cost selection unit selects a unit cost of a crop corresponding to the crop to be planted from the unit sales of the plurality of types of crops stored in the storage unit.

The cost calculation unit then calculates the cost of the crop to be planted based on the planting area set by the condition setting unit and the unit cost selected by the unit-cost selection unit. The calculated unit cost of the crop is calculated based on the total cost required for a series of operation from the preparation operation to the shipping operation for the farm field, and so the system enables more precise calculation of the cost for the crop to be planted. This allows the manager to precisely understand the input cost for the crop to be planted for sales that is a required cost before the sales.

The “unit cost for a crop per planting unit area” in the present disclosure is a value calculated by dividing the total cost of the crop by planting area where the crop was planted. The “cost of a crop to be planted” calculated by the cost calculation unit in the present disclosure may be a value calculated by multiplying the planting area set for the crop and the unit cost set for the crop. This value may be multiplied by a correction coefficient, for example, or a correction value (of money) may be added to this value.

In one example, when a plurality of types of crops is planted at a single farm field at different timings, the farming support system may calculate the cost for each crop. In some embodiments, the condition setting unit segments a farm field to be used for planting into a plurality of sections, and sets a crop to be planted and the planting area corresponding to the area of the section for each of the segmented sections, the unit-cost selection unit selects a unit cost corresponding to the crop to be planted for each of the sections from unit costs of the plurality of crops stored in the storage unit, and the cost calculation unit calculates a cost of the crop to be planted for each of the sections based on the set planting area and the selected unit cost.

According to this embodiment, the cost calculation unit calculates the cost of the crop to be planted for each of the segmented sections in the farm field. This enables more precise understanding of the expense to be input to the farm field as a whole. This allows the manager to appropriately set the areas of the segmented sections in the farm field, and the crop to be planted at each section so that the expense fits within the budget that the manager is able to input to the farm field. The farm field in the present disclosure includes not only a single continuous land but also the combination of a plurality of lands that are away from each other.

In some embodiments, the storage unit stores unit sales of a crop per unit planting area for each of the plurality of types of crops, the unit sales being calculated based on sales proceeds of the crops that were sold, the unit-cost selection unit selects unit sales corresponding to the crop to be planted for each of the sections from the unit sales of the plurality of types of crops stored in the storage unit, and the farming support system further comprises: an expected sales calculation unit configured to calculate an expected sales proceeds of the crop to be planted for each of the sections based on the set planting area and the selected unit sales; a profit calculation unit configured to calculate an amount of profit for each of the sections from the expected sales proceeds and the cost of the crop to be planted; and a revenue calculation unit configured to add the amounts of profit calculated for the sections to calculate revenue of the farm field.

According to this embodiment, the storage unit stores a unit sales of each crop per unit planting area. The unit-cost selection unit selects unit sales of a crop corresponding to the crop to be planted for each of the sections from unit sales of the plurality of types of crops stored in the storage unit.

The expected sales calculation unit calculates an expected sales proceeds of the crop to be planned for each of the sections based on the planting area set for the section and the unit sales selected for the crop to be planned at the section. Specifically the expected sales proceeds may be a value calculated by the planting area and the sales proceeds. This value may be multiplied by a correction coefficient for each crop, for example, depending on the timing of sale, or a correction value (of money) depending on the timing of sale may be added to this value.

The profit calculation unit calculates an amount of profit for each of the sections from the expected sales proceeds of the crop to be planted and the cost of the crop to be planted. Specifically the amount of profit may be a value calculated by subtracting the cost of the crop to be planted from the expected sales proceeds. This value may be multiplied by a correction coefficient for each crop, for example, depending on the timing of sale, or a correction value (of money) depending on the timing of sale may be added to this value.

In this way, the manager is able to understand the amount of profit of the crop to be planted for each of the sections, and so is able to understand the section having a high profit ratio of the crop. The revenue calculation unit adds the amounts of profit calculated for the sections to calculate the revenue of the farm field. This allows the manager to optimally select the areas of the segmented sections in the farm field, and the crop for each section to conduct optimum and profitable farming for the farm field.

In some embodiments, the condition setting unit sets a plurality of types of crops for each of the sections depending on a season for planting. In this way, the condition setting unit is able to set the farm work of the crops at different periods for each of the sections. This allows the manager to understand the revenue at the farm field as needed in a certain period, such as in a year.

The present disclosure precisely calculates the cost of crops to be planted for sales.

### BRIEF DESCRIPTION OF THE DRAWINGS

FIG. 1 schematically shows a farming support system according to a first embodiment of the present disclosure;

FIG. 2 is a table showing the relationship of the details of the operation and the expenses for crops for each period;

FIG. 3 is a block diagram of the farming support system of FIG. 1;

FIG. 4 shows a map data indicating the farm field and their sections in the farming support system according to a second embodiment;

FIG. 5 shows a result of a series of processing in the farming support system according to the second embodiment;

FIG. 6 shows another map data indicating the farm field and their sections in the farming support system according to the second embodiment;

FIG. 7 is a block diagram of a farming support system according to a third embodiment;

FIG. 8 shows a result of a series of processing in the farming support system according to the third embodiment;

FIG. 9 describes planting conditions set by the condition setting unit in a modified example of the third embodiment;

FIG. 10 describes planting conditions set by the condition setting unit in another modified example of the third embodiment; and

FIG. 11 shows the transition of the sales unit cost for each of the crops stored in the management information storage unit of FIG. 3.

### DETAILED DESCRIPTION

Referring to the drawings, the following describes some embodiments of a farming support system according to the present disclosure.

### First Embodiment

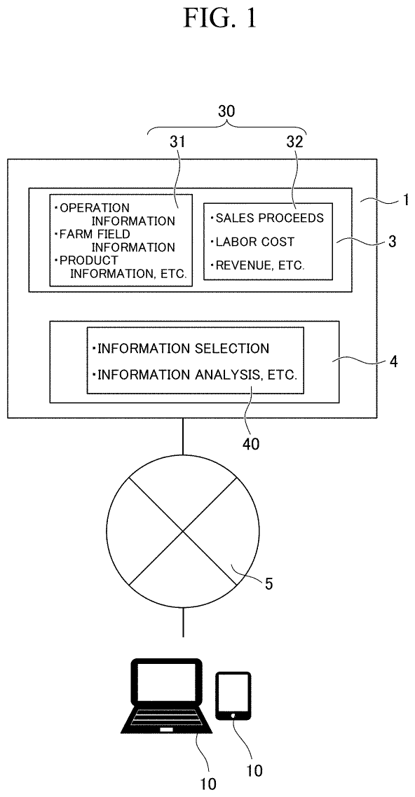

As shown in FIG. 1, a farming support system 1 includes, as hardware components, a storage device 3, such as a ROM or a RAM, to store farming information and management information on a farm producer (manager), and an arithmetic device 4, such as a CPU, to select each piece of the farming information and the management information and associate these pieces of information, and then make an analysis based on these pieces of information. The farming support system 1 is able to input and output farming information described later via a communication terminal 10 through a network 5 (through a network circuit). The communication terminal 10 may be a personal computer or a mobile terminal.

The farming support system 1 includes, as software components, a storage unit 30 to store farming information and management information on a farm producer as data, and an analysis unit 40 to select each piece of the farming information and the management information in the storage unit 30 and associate these pieces of information, and then make a predetermined analysis based on these pieces of information. The storage unit 30 is implemented in the form of a database in the storage device 3, and the analysis unit 40 is implemented in the form of a program in the arithmetic device 4. The storage unit 30 stores the information analyzed by the analysis unit 40, and the stored information updates the database in the storage unit 30.

As shown in FIG. 1 and FIG. 3, the storage unit 30 of the present embodiment includes a farming information storage unit 31 to store farming information and a management information storage unit 32 to store management information in the single farming support system 1, and the analysis unit 40 makes an analysis described later based on such information. In another embodiment, different systems have the farming information storage unit 31 and the management information storage unit 32 separately, and each of the systems has an analysis unit. These systems then are connectable to the communication terminal 10 via a network.

The farming information storage unit 31 of the storage unit 30 stores farming information containing a farm field database (farm field information) and a crops database (product information). The farm field database records the position and the area of the farm field owned by the farm producer, and the crops database records the types of the crops, for example, to be planted in the farm field. The farming information storage unit 31 also stores an operation database (operation information), a material database (material information), an equipment database (equipment information), a sales database (sales information) and the like as the farming information. The operation database records the operational time and the details of the operation conducted at each of the farm field. The material database records the types and the amount of materials that the farm producer owns. The equipment database records the types and the number of the agricultural implements that the farm producer owns. The sales database records the sales proceeds and the volume of the sales of the harvested crops.

The farming information storage unit 31 combines data in these databases and creates operational plan data on the farm work. The farming information storage unit 31 stores, as the farming information, this operational plan data as well as operational performance data that is the actual performance of the farm work. Such data is stored in the farming information storage unit 31, and a single server (cloud server), i.e., the farming support system 1 manages this data.

The management information storage unit 32 stores a database on the sales proceeds from the entire farm field, a database on the personnel cost (labor cost) including the hourly wage of an operator in each farm work, a database on the amount of profit for each of the crops, a database on the revenue from the farm field, and the like.

The analysis unit 40 calculates the actual cost required for each of a plurality of types of crops based on the databases stored in the farming information storage unit 31 and the databases stored in the management information storage unit 32. “A plurality of types of crops” referred to in the present disclosure and in the following descriptions may include a plurality of different items, such as “rice”, “soybean” and “wheat”, or may include a plurality of different varieties of a single item, such as rice.

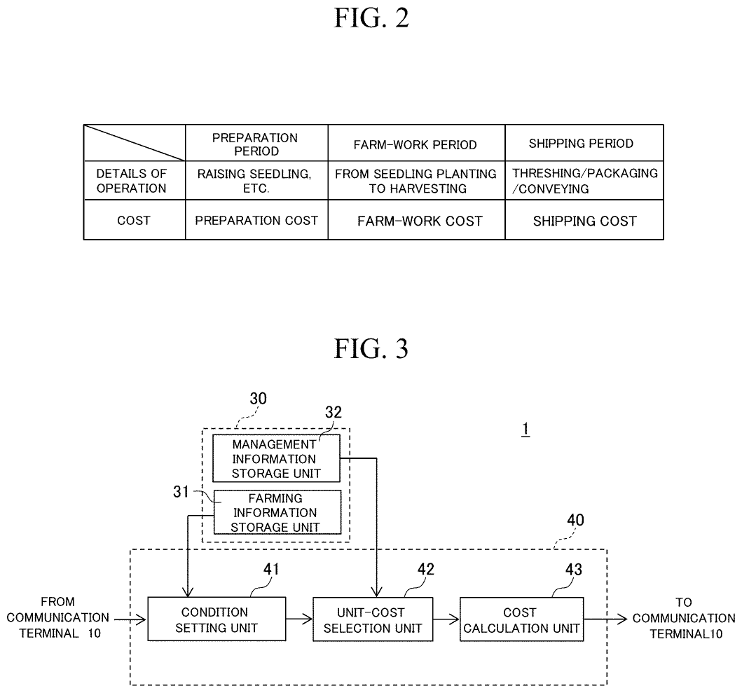

Specifically as shown in FIG. 2, the period at a farm field before selling of crops to the market is segmented into three sections including a preparation period, a farm-work period, and a shipping period. Then, the analysis unit 40 calculates the actual expenses required for each of these periods. The expense calculated for each period includes not only the personnel cost based on the work hours required for the period but also the expense of the material required for the period (material cost) and the expense of the implements used for the period, for example.

Specifically the preparation period is a period required for the preparation operation before planting of each of the crops at the farm field. For instance, for sales of rice, the preparation operation includes raising seedling conducted during the preparation period before planting of seedling in the paddy field. The analysis unit 40 calculates the personnel cost for the operation based on the operational time of the raising seedling and the hourly wage of the operators stored in the farming information storage unit 31, and adds this to the expense of the implements to be used for the raising seedling (cost of equipment), and the material cost, such as the price of seedling and the price of fertilizer used for raising seedling to calculate the preparation cost.

For other crops, such as vegetables, as well, preparation is required before seeding at the farm field. The analysis unit 40 therefore adds the personnel cost, the cost of equipment, and the material cost required for this preparation operation to calculate the preparation cost. In this way, the analysis unit 40 calculates the preparation cost required for the preparation operation of each of the crops before planting of the crop at the farm field. The management information storage unit 32 may store the preparation cost calculated by the analysis unit 40.

After the preparation operation ends, the process shifts to the farm-work period. The farm-work period is a period for planting of each of the crops at the farm field and harvesting the crops. The farm work is the operation performed during this period. For instance, for sales of rice, the farm-work period includes, as the farm work, planting of the raised seedling at the paddy field, raising the seedling to rice, and harvesting the rice. The analysis unit 40 calculates the personnel cost based on the operational time at the farm field and the hourly wage of the operators stored in the farming information storage unit 31, and adds this personnel cost to the expense of the implements used at the farm field (cost of equipment), and the material cost, such as for fertilizer and agricultural chemicals used for raising rice to calculate the farm-work cost. The expense for agricultural implements here and the expense for agricultural implements described later also include the fuel cost to operate the agricultural implements, for example.

For other crops, such as vegetables, as well, the analysis unit 40 adds the personnel cost, the cost of equipment, and the material cost required for the farm-work for the crops at the farm field to calculate the farm-work cost. In this way, the analysis unit 40 calculates the farm-work cost for each crop required for the farm work after the preparation operation, including planting of the crops at the farm field and harvesting the crops. The management information storage unit 32 may store the farm-work cost calculated by the analysis unit 40.

After the farm work of harvesting the crops ends, the process shifts to the shipping period. The shipping period is a period after harvesting the crops and till shipping the crops. The shipping operation is the operation performed during the period. For instance, for sales of rice, the shipping period includes, as the shipping operation, threshing the rice, polishing brown rice obtained by threshing, packaging the polished rice, and conveying the rice to the sale destination. The analysis unit 40 calculates the personnel cost based on the operational time for the shipping operation and the hourly wage of the operators stored in the farming information storage unit 31, and adds this personnel cost to the expense of the implements used for rice threshing and polishing (cost of equipment) to calculate the shipping cost.

For other crops, such as vegetables, as well, the analysis unit 40 adds the personnel cost, the cost of equipment, and the material cost required for the shipping operation to calculate the shipping cost. In this way the analysis unit 40 calculates the shipping cost for each of the crops required after harvesting the crops and till shipping the crops. The management information storage unit 32 may store the shipping cost calculated by the analysis unit 40.

The analysis unit 40 then adds the preparation cost, the farm-work cost, and the shipping cost calculated for each of the crops to calculate a total cost. This total cost is the cost (the actual expense) for the crops actually required for the farm field. The management information storage unit 32 may store this total cost. The analysis unit 40 then calculates the unit cost for each of the crops per unit area of the farm field. This calculation of the unit cost is made based on the total cost calculated for each of the crops and the area of the farm field where the crop was actually planted. Specifically the analysis unit 40 divides the total cost for each of the crops by the area of the farm field where the corresponding crop is planted to calculate the unit cost for the crop. The management information storage unit 32 stores the calculated unit cost for each of the crops. In this way the unit cost for each of the crops is calculated while considering a series of the operation from the preparation operation to the shipping operation, and then the management information storage unit 32 stores the unit cost as a database.

In the present embodiment the analysis unit 40 calculates the unit cost for each of the crops while considering a series of the operation from the preparation operation to the shipping operation, and then the management information storage unit 32 stores the unit cost. In another embodiment, another arithmetic device (not shown) may calculate the unit cost for each of the crops while considering the series of operation, and the management information storage unit 32 may store this unit cost via an input device (not shown).

In the present embodiment, the analysis unit 40 of the farming support system 1 has a program shown in FIG. 3 as well. Specifically the analysis unit 40 includes a condition setting unit 41, a unit-cost selection unit 42 and a cost calculation unit 43 to calculate the cost of the crops to be planted (to be sold). The cost means the overall expense for the crop that is required during a series of the operation until the crop is shipped as a commodity.

The condition setting unit 41 sets a crop to be planted and the planting area for the crop to be planted. The farming support system 1 sets this information based on information received with the communication terminal 10. To this end, the farm producer accesses the farming support system 1 with the communication terminal 10. As described above, the farming support system 1 stores data on a plurality of crops relating to the unit cost in the management information storage unit 32. The farm producer selects a crop to be planted from the plurality of crops with the communication terminal 10. In this way, the farm producer inputs a planting condition to the farming support system 1 with the communication terminal 10. Then the condition setting unit 41 in the farming support system 1 sets the crop to be planted based on the set condition.

As described above, the farming information storage unit 31 stores farm field data recording the position and the area of the farm field that the farm producer owns. The farm producer selects the farm field with the communication terminal 10. When the farm field is segmented into a plurality of sections, the farm producer then selects a section to be used for the planting. In this way, the farm producer inputs a planting condition to the farming support system 1 with the communication terminal 10. Then the condition setting unit 41 in the farming support system 1 sets the planting area of the crop to be planted.

The unit-cost selection unit 42 reads the unit cost of the crop corresponding to the crop to be planted from the management information storage unit 32. Specifically based on the crop set by the condition setting unit 41, the unit-cost selection unit 42 selects the unit cost corresponding to the set crop (crop to be planted) from the unit costs of a plurality of crops stored in the management information storage unit 32. In this way the crop to be planted is associated with the corresponding unit cost.

The cost calculation unit 43 calculates the cost (expected cost) of the crop to be planted based on the planting area of the crop to be planted that is set by the condition setting unit 41 and the unit cost of the crop to be planted that is selected by the unit-cost selection unit 42. Specifically the cost calculation unit 43 multiplies the unit cost selected for the crop by the planting area set for the crop to calculate the cost of the crop to be planted. The same farm field may be set for the unit cost for the crop and the price for the crop to be planted, and this enables more precise calculation of the cost of the crop to be planted. Different farm fields may be set for this purpose. Data obtained from this series of processing is output to the communication terminal 10.

In the present embodiment, the unit cost of a crop stored in the management information storage unit 32 of the storage unit 30 is calculated based on the total cost including not only the farm-work cost required for the farm work from planting of the crop at the farm field to harvesting the crop but also the preparation cost before the farm work and the shipping cost after the farm work. The unit cost of each crop stored in the management information storage unit 32 therefore is calculated while considering the cost more precisely.

The cost calculation unit 43 calculates the cost of the crop to be planted based on such a unit cost, and so enables more precise calculation of the cost of the crop to be planted. This allows the manager to precisely understand the input cost for the crop to be planted for sales that is a required cost before the sales.

### Second Embodiment

Referring to FIG. 3 to FIG. 6, the following describes a farming support system according to a second embodiment. The farming support system according to the second embodiment is different from the first embodiment in specific processing by the condition setting unit 41, the unit-cost selection unit 42, and the cost calculation unit 43 of the analysis unit 40. The following omits the detailed descriptions on the same configuration as in the first embodiment.

Similarly to the first embodiment, the farming support system 1 according to the present embodiment includes a condition setting unit 41, a unit-cost selection unit 42, and a cost calculation unit 43 shown in FIG. 3. The condition setting unit 41 of the present embodiment segments a farm field to be used for planting into a plurality of sections, and sets a crop to be planted and the planting area corresponding to the area of the section for each of the segmented sections.

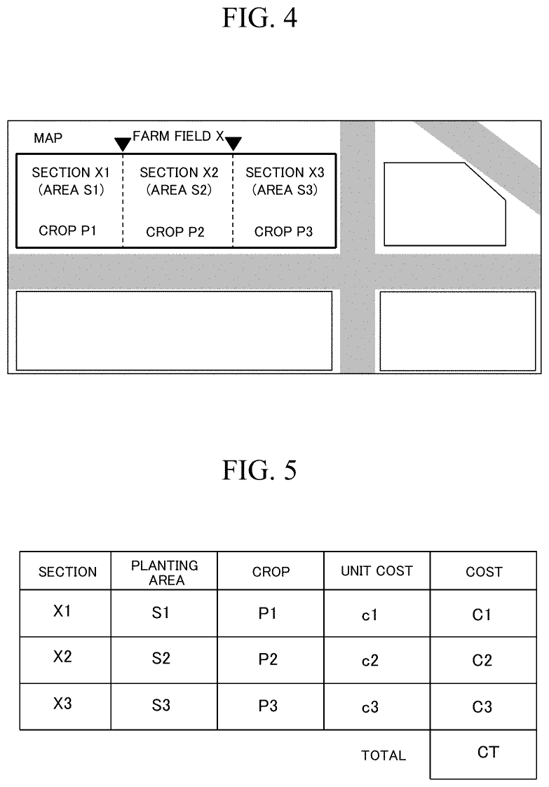

Receiving input information via the communication terminal 10, the farming support system 1 sets such information. To this end, the farm producer accesses the farming support system 1 with the communication terminal 10. The communication terminal 10 then shows a map as shown in FIG. 4, for example, based on the data in the farming information storage unit 31.

As shown in FIG. 4, when the farm producer manages a farm field X, the farm producer is able to select the farm field X to be used for planting, and the farm producer is able to divide the farm field X shown on the screen of the communication terminal 10 into a plurality of sections. Let that the area of the farm field X is 100%, the condition setting unit 41 enables division of the farm field X with the area ratios so that the total area ratio is 100%. FIG. 4 shows the example where the farm field X is segmented into three sections of X1 to X3 based on the input with the communication terminal 10. In this way, the condition setting unit 41 in the farming support system 1 divides the farm field X to be used for planting into a plurality of sections X1 to X3 based on the planting condition input by the farm producer with the communication terminal 10, and sets the planting area S1 to S3 corresponding to the area of the section for each of the segmented sections X1 to X3.

In the farming support system 1, the management information storage unit 32 stores data on a plurality of types of crops P1, P2, P3, . . . associated with their unit costs c1, c2, c3, . . . The farm producer then selects crops P1 to P3 to be planted for each of the segmented sections X1, X2 and X3 from these plurality of types of crops P1, P2, P3, . . . with the communication terminal 10. When the farm producer inputs the planting condition with the communication terminal 10 in this way, then as shown in FIG. 5, the condition setting unit 41 in the farming support system 1 sets the crops P1, P2, and P3 to be planted for the sections X1, X2, and X3, respectively, based on the planting condition.

As shown in FIG. 5, the unit-cost selection unit 42 reads the unit costs c1, c2, and c3 of the crops corresponding to the crops P1, P2 and P3, respectively, to be planted for the sections X1, X2 and X3 from the management information storage unit 32. Specifically based on the crops set by the condition setting unit 41, the unit-cost selection unit 42 selects the unit costs c1, c2, and c3 corresponding to the set crops (crops to be planted) P1, P2, and P3 for the sections X1, X2, and X3, respectively, from the unit costs c1, c2, c3 . . . of the plurality of crops P1, P2, P3, . . . stored in the management information storage unit 32. In this way as shown in FIG. 5, the crop to be planted P1, P2, P3 is associated with their corresponding unit cost c1, c2, c3 for each of the sections X1, X2, X3.

The cost calculation unit 43 calculates the costs (expected costs) C1, C2, and C3 of the crops P1, P2, and P3 to be planted for the sections X1, X2, and X3, respectively. This calculation is conducted based on the planting areas S1, S2, and S3 set by the condition setting unit 41 and the unit costs c1, c2, and c3 selected by the unit-cost selection unit 42. Specifically the cost calculation unit 43 multiplies the planting area S1, S2, S3 set for each crop P1, P2, P3 by the unit cost c1, c2, c3 selected for the crop P1, P2, P3 for each of the sections X1, X2, X3 (e.g., S1×c1) to calculate the cost C1 to C3 for the crops P1 to P3 to be planted. The cost calculation unit 43 may add these costs C1, C2 and C3 to calculate the total cost CT of the farm field X. Data obtained from this series of processing is output to the communication terminal 10 in the form of the table shown in FIG. 5, for example.

According to this embodiment, the cost calculation unit 43 calculates the costs C1, C2, and C3 of the crops P1, P2, and P3 to be planted for the segmented sections X1, X2, and X3, respectively, in the farm field X. This enables more precise understanding of the expense to be input to the farm field X as a whole. This allows the manager to appropriately set the number of segmented sections in the farm field X, the area of each section, and the crop to be planted at each section so that the expense fits within the budget that the manager is able to input to the farm field X.

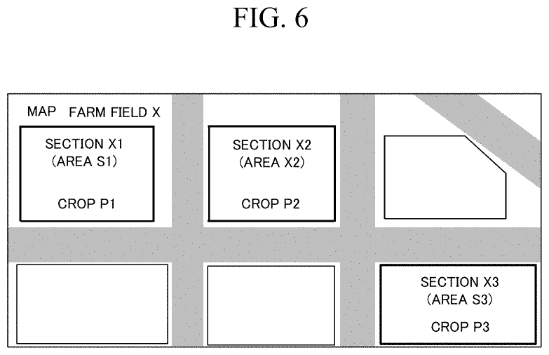

The present embodiment describes the case of the farm field X that is a single continuous land as shown in FIG. 4. In another embodiment, as shown in FIG. 6, a plurality of lands that are away from each other may be considered as a single farm field X, and the condition setting unit 41 may segment such a farm field X into sections X1, X2 and X3. The condition setting unit 41 may further segment each of the lands.

### Third Embodiment

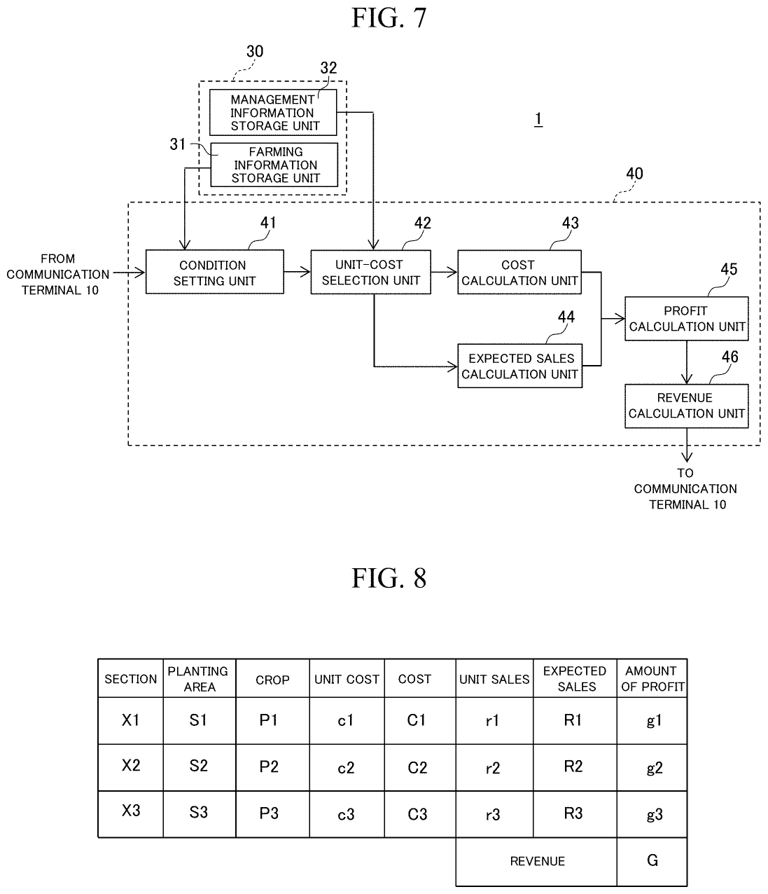

Referring to FIG. 7 and FIG. 8, the following describes a farming support system according to a third embodiment. The farming support system 1 according to the third embodiment is mainly different from the second embodiment in that the analysis unit 40 additionally includes an expected sales calculation unit 44, a profit calculation unit 45, and a revenue calculation unit 46. The following omits the detailed descriptions on the same configuration as in the second embodiment.

As shown in FIG. 8, the farming support system 1 of the present embodiment calculates the amount of profit g1, g2, g3 for each of the segmented sections X1, X2, and X3 of the farm field X, and the revenue G of the farm field X. In the present embodiment, the management information storage unit 32 of the storage unit 30 stores unit sales r1, r2, r3, . . . of crops per planting unit area for each of a plurality of types of crops P1, P2, P3, . . . The unit sales is calculated based on the sales proceeds of the crops that were sold in the past.

Specifically the analysis unit 40 divides the sales proceeds of each of the crops P1, P2, P3, . . . that were produced at their planting areas for selling by the predetermined planting area to calculate the unit sales of the crop per unit planting area, and the management information storage unit 32 stores the unit sales r1, r2, r3, . . . for each of the crops P1, P2, P3, . . .

In the present embodiment the analysis unit 40 calculates the unit sales of each of the crops, and the management information storage unit 32 stores the unit sales for each of the crops. In another embodiment, another arithmetic device (not shown) may calculate the unit sales for each of the crops, and the management information storage unit 32 may store the unit sales via an input device (not shown).

The unit-cost selection unit 42 of the present embodiment selects the unit sales r1, r2, and r3 corresponding to the crops P1, P2, and P3 to be planted for the sections X1, X2 and X3, respectively, from the unit sales r1, r2, r3, . . . of the plurality of types of crops P1, P2, P3 . . . that are stored in the management information storage unit 32. In this way as shown in FIG. 8, the crops to be planted P1, P2, and P3 are associated with their corresponding unit sales r1, r2, and r3 for each of the sections X1, X2, X3.

As shown in FIG. 8, the expected sales calculation unit 44 calculates expected sales proceeds R1, R2, and R3 of the crops to be planted P1, P2, and P3 for each of the sections X1, X2 and X3 based on the planting area S1, S2, and S3 set by the condition setting unit 41 and the unit sales r1, r2, and r3 selected by the unit-cost selection unit 42.

Specifically the expected sales calculation unit 44 multiplies the planting area S1, S2, S3 set for the crop P1, P2, P3 by the unit sales r1, r2, r3 selected for the crop P1, P2, P3 for each of the sections X1, X2, X3 (e.g., S1×r1) to calculate the expected sales proceeds R1, R2, and R3 of the crops P1 to P3 to be planted.

As shown in FIG. 8, the profit calculation unit 45 calculates the amount of profit g1, g2, g3 for each of the sections X1, X2 and X3. This calculation is conducted based on the expected sales proceeds R1, R2, R3 of the crops to be planted P1, p2 and P3 that is calculated by the expected sales calculation unit 44 and the cost C1, C2, and C3 of the crops to be planted P1, P2, and P3 that is calculated by the cost calculation unit 43.

Specifically the profit calculation unit 45 subtracts the cost C1, C2, C3 calculated for each of the crops P1, P2 and P3 from the expected sales proceeds R1, R2, R3 calculated for each of the crops P1, P2 and P3 for each of the sections X1, X2 and X3 (e.g., R1-C1) to calculate the amount of profit g1, g2, g3 of the crops to be planted P1 to P3.

The revenue calculation unit 46 adds the amounts of profit g1, g2 and g3 calculated for the sections X1, X2 and X3 to calculate the revenue G of the farm field X. Data obtained from this series of processing is output to the communication terminal 10 in the form of the table shown in FIG. 8, for example.

In this way, the manager is able to understand the amount of profit g1, g2, and g3 of the crops to be planted P1, P2, and P3 for each of the sections X1, X2, and X3, and so is able to understand the section X having a high profit ratio of the crop. The revenue calculation unit 46 adds the amounts of profit g1, g2 and g3 calculated for the sections X1, X2 and X3 to calculate the revenue G of the farm field X. This allows the manager to optimally select the number of segmented sections of the farm field X, the area of each section, and the crop for each section to conduct optimum and profitable farming for the farm field X.

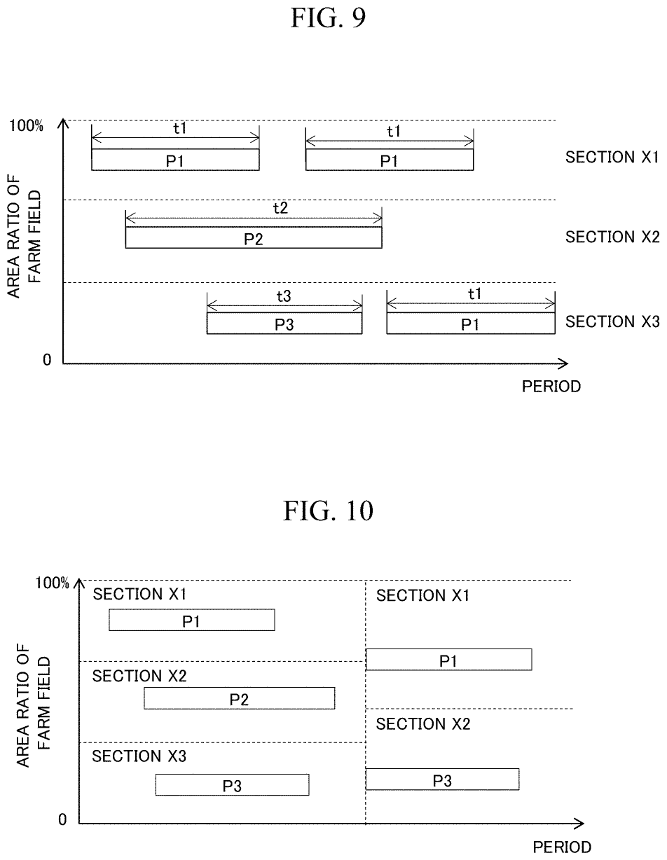

As shown in FIG. 9, the condition setting unit 41 may set a plurality of crops for each of the sections X1, X2 and X3 in accordance with the season for planting. The condition setting unit 41 of the present embodiment is able to set a plurality of crops in accordance with the period t1, t2, and t3 of the farm work for the crops P1, P2 and P3 from the scheduled planting time to the scheduled harvesting time (specifically so that the set timing of the farm work for the crops P1, P2 and P3 are not overlapped). The farming information storage unit 31 stores the information on the farm-work periods t1, t2, t3, . . . To set a condition for the crops P1, P2 and P3 for each of the sections X1, X2 and X3, the condition setting unit 41 reads this period t1, t2, t3, . . . of the farm work that is associated with the crops P1, P2, and P3 from the farming information storage unit 31.

In FIG. 9, the crop P1 is set in the section X1 so that the farm work of the crop P1 from planting to harvesting is conducted during two seasons in a predetermined period (e.g., one year). The crop P2 is set in the section X2 so that the farm work of the crop P2 from planting to harvesting is conducted in the predetermined period. The crops P1 and P3 are set in the section X3 so that, following the farm work of the crop P3 from planting to harvesting, the farm work of the crop P1 from planting to harvesting is conducted in the predetermined period.

In this way, the condition setting unit 41 is able to set the planting timing through the harvesting timing of the crops P1, P2 and P3 for each of the sections X1, X2 and X3 in the predetermined period. This allows the manager to understand the amount of profit for each of the sections X1, X2 and X3 and the revenue of the farm field X during a certain period, such as in a year.

As shown in FIG. 10, the condition setting unit 41 may change the number of segmentation of the farm field X depending on the season for planting, and may set the planting area of the section X1, X2 for planting so as to change the area ratios of the segmented sections X1 and X2 of the farm field X. In another embodiment, the condition setting unit 41 may set the planting areas of the sections X1, X2 and X3 for planting without changing the number of segmentation of the farm field X so as to change the area ratios of the segmented sections X1, X2 and X3 of the farm field X.

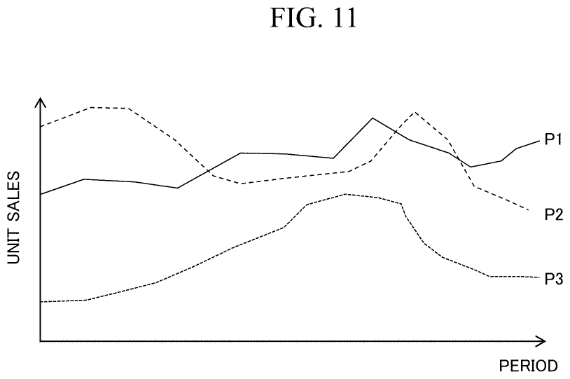

As shown in FIG. 11, the management information storage unit 32 may store, as the actual performance in the past, the unit sales for each of the crops P1, P2 and P3 corresponding to the timing of sale in one year. In this case, the expected sales calculation unit 44 may calculate the expected sales proceeds of the crops P1, P2 and P3 based on the unit sales of the crops P1, P2 and P3 to be planted depending on the timing of sale.

This allows the manager to confirm the expected sales proceeds of the crops P1, P2 and P3 that will vary with the timing of sale. This enables production and shipping of optimum crops at optimum timing for each of the sections, and so allows farming of the farm field so as to earn higher revenue over a specific duration in a year, for example.

That is a detailed description of the embodiments of the present disclosure. The present disclosure is not limited to the above-stated embodiments, and the design may be modified variously without departing from the spirits of the present disclosure.

The present embodiment segments the farm field to be used for planting into three sections, and the number of sections is not limited especially. The above embodiment sets a crop to be planted for the segmented section. In another embodiment, when no crops are planted at a part of the sections, the condition setting unit may not set any crops for this section.

What is claimed is:

1. A farming support system comprising:
a storage unit configured to store a unit cost for each of a plurality of types of crops per unit planting area, the unit cost being calculated from a total cost including: a preparation cost required for a preparation operation before planting of the crop; a farm-work cost required for farm work of the crop after the preparation operation, the farm work including planting through harvesting of the crop; and a shipping cost required for shipping operation to ship the harvested crop;
a condition setting unit configured to set a crop to be planted and a planting area for the crop;
a unit-cost selection unit configured to select a unit cost corresponding to the crop to be planted from unit costs of the plurality of crops stored in the storage unit; and
a cost calculation unit configured to calculate a cost of the crop to be planted based on the set planting area and the selected unit cost.

2. The farming support system according to claim 1, wherein
the condition setting unit segments a farm field to be used for planting into a plurality of sections, and sets a crop to be planted and the planting area corresponding to the area of the section for each of the segmented sections,
the unit-cost selection unit selects a unit cost corresponding to the crop to be planted for each of the sections from unit costs of the plurality of crops stored in the storage unit, and
the cost calculation unit calculates a cost of the crop to be planted for each of the sections based on the set planting area and the selected unit cost.

3. The farming support system according to claim 2, wherein
the storage unit stores unit sales of a crop per unit planting area for each of the plurality of types of crops, the unit sales being calculated based on sales proceeds of the crops that were sold,
the unit-cost selection unit selects unit sales corresponding to the crop to be planted for each of the sections from the unit sales of the plurality of types of crops stored in the storage unit, and
the farming support system further comprises: an expected sales calculation unit configured to calculate an expected sales proceeds of the crop to be planted for each of the sections based on the set planting area and the selected unit sales;
a profit calculation unit configured to calculate an amount of profit for each of the sections from the expected sales proceeds and the cost of the crop to be planted; and
a revenue calculation unit configured to add the amounts of profit calculated for the sections to calculate revenue of the farm field.

4. The farming support system according to claim 3, wherein the condition setting unit sets a plurality of types of crops for each of the sections depending on a season for planting.
